(19) United States
(12) Patent Application Publication
(10) Pub. No.: US 2019/0186311 A1
(43) Pub. Date: Jun. 20, 2019

(54) ACTUATOR OF LINK MECHANISM FOR INTERNAL COMBUSTION ENGINE

(71) Applicant: HITACHI AUTOMOTIVE SYSTEMS, LTD., Hitachinaka-shi, Ibaraki (JP)

(72) Inventors: Kishiro NAGAI, Atsugi-shi, Kanagawa (JP); Junichiro ONIGATA, Atsugi-shi, Kanagawa (JP)

(73) Assignee: HITACHI AUTOMOTIVE SYSTEMS, LTD., Hitachinaka-shi, Ibaraki (JP)

(21) Appl. No.: 16/322,057

(22) PCT Filed: Jul. 28, 2017
(86) PCT No.: PCT/JP2017/027420

§ 371 Date: Jan. 30, 2019

(30) Foreign Application Priority Data
Aug. 2, 2016 (JP) 2016-151934

(51) Int. Cl. F01M 9/10; F02B 75/04; F02B 75/32; F16H 57/04; H02K 7/116

(52) U.S. Cl. CPC F01M 9/107; F02B 75/04; H02K 7/116; F16H 57/04; F02B 75/32

(57) ABSTRACT

An object of the present invention is to provide an actuator of a link mechanism for an internal combustion engine capable of ensuring lubricity regardless of a slope of a road surface. An actuator of a link mechanism for an internal combustion engine according to one aspect of the present invention includes a ball bearing having an inner race held by a wave generator of a strain wave gearing speed reducer and an outer race held by a housing, and a holding mechanism capable of holding lubricant oil on a radially inner side with respect to the outer race of this roller bearing.

### TECHNICAL FIELD

The present invention relates to an actuator of a link mechanism for an internal combustion engine.

### BACKGROUND ART

As this kind of technique, there is disclosed a technique discussed in the following patent literature, PTL 1. PTL 1 discloses a variable compression ratio mechanism that makes a compression ratio of an internal combustion engine variable by changing a stroke characteristic of a piston with use of a multi-link piston-crank mechanism.

Further, an actuator includes a control link configured to vary an operating characteristic of the link mechanism for the internal combustion engine, an arm link relatively rotatably connected to the control link via a connection pin, a control shaft inserted and fixed in a fixing hole provided at the arm link, a housing including a receiving portion in which a connection portion between the other end portion of the control link and the arm link is received, and rotatably supporting the control shaft in a support hole formed within the housing, and a strain wave gearing speed reduction device configured to reduce a rotation speed of a driving motor and transmit the reduced rotation to the control shaft. A wave generator of the strain wave gearing speed reduction device is held by a ball bearing.

### CITATION LIST

### Patent Literature

[PTL 1] Japanese Patent Application Public Disclosure No. 2015-145647

### SUMMARY OF INVENTION

### Technical Problem

The receiving chamber of the actuator discussed in PTL 1 is filled with lubricant oil so as to lubricate the ball bearing. However, the technique discussed in PTL 1 may lead to a tilt of an oil level in the receiving chamber and thus a drop of a height of the oil level when the actuator tilts on, for example, an uphill road. In this case, the supply of the lubricant oil to the ball bearing may fall shaft. This raises such a drawback that an increase in an output torque also leads to an increase in a load imposed on the actuator especially on the uphill road, and the insufficiency of the lubricant oil results in a reduction in durability of the ball bearing.

An object of the present invention is to provide an actuator of a link mechanism for an internal combustion engine capable of ensuring lubricity regardless of the tilt.

### Solution to Problem

According to one aspect of the present invention, an actuator of a link mechanism for an internal combustion engine includes a roller bearing having an inner race held by a wave generator of a strain wave gearing speed reducer and an outer race held by a housing, and a holding mechanism capable of holding lubricant oil on a radially inner side with respect to the outer race of this roller bearing.

Therefore, according to the one aspect of the present invention, the actuator can secure the lubricant oil to the roller bearing, thereby improving a wear-resistant performance of the roller bearing holding the wave generator.

### BRIEF DESCRIPTION OF DRAWINGS

FIG. 1 schematically illustrates an internal combustion engine including an actuator of a link mechanism for the internal combustion engine according to the present invention.

FIG. 2 is an exploded perspective view of the actuator of the link mechanism for the internal combustion engine according to a first embodiment.

FIG. 3 is a perspective view of the actuator of the link mechanism for the internal combustion engine according to the first embodiment.

FIG. 4 is a left side view of the actuator of the link mechanism for the internal combustion engine according to the first embodiment.

FIG. 5 is a cross-sectional view taken along a line A-A that illustrates the actuator of the link mechanism for the internal combustion engine in FIG. 4.

FIG. 6 is an exploded perspective view of a strain wave gearing speed reducer according to the first embodiment.

FIG. 7 is a cross-sectional view of main portions near the strain wave gearing speed reducer according to the first embodiment.

FIG. 8 schematically illustrates a change in a height of an oil level between running on a flatland and running on an uphill road according to the first embodiment.

FIG. 9 is a cross-sectional view of main portions near a strain wave gearing speed reducer according to a second embodiment.

FIG. 10 is a cross-sectional view of main portions near a strain wave gearing speed reducer according to a third embodiment.

FIG. 11 is a cross-sectional view of main portions near a strain wave gearing speed reducer according to a fourth embodiment.

### DESCRIPTION OF EMBODIMENTS

### First Embodiment

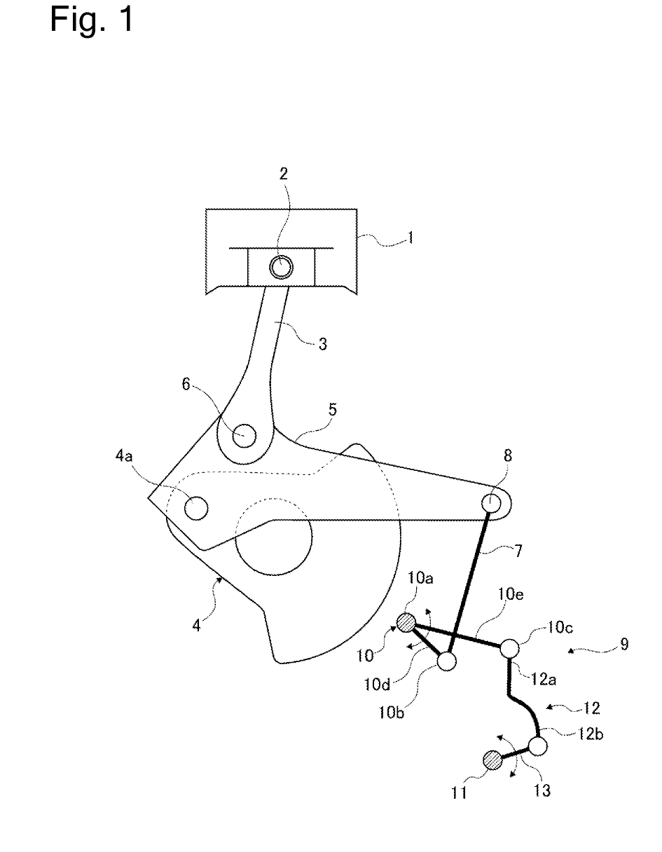

FIG. 1 schematically illustrates an internal combustion engine including an actuator of a link mechanism for the internal combustion engine according to the present invention. This internal combustion engine has a basic configuration similar to the configuration illustrated in FIG. 1 of Japanese Patent Application Public Disclosure No. 2011-169152, and therefore will be described briefly herein.

An upper end of an upper link 3 is rotatably coupled with a piston 1 via a piston pin 2. The piston 1 reciprocates in a cylinder of a cylinder block of the internal combustion engine. A lower link 5 is rotatably coupled with a lower end of the upper link 3 via a coupling pin 6. A crankshaft 4 is rotatably coupled with the lower link 5 via a crank pin 4a. Further, an upper end portion of a first control link 7 is rotatably coupled with the lower link 5 via a coupling pin 8. A lower end portion of the first control link 7 is coupled with a coupling mechanism 9, which includes a plurality of link members. The coupling mechanism 9 includes a first control shaft 10, a second control shaft 11, and a second control link 12 that couples the first control shaft 10 and the second control shaft 11 with each other.

The first control shaft 10 extends in parallel with the crankshaft 4 extending in a direction of a cylinder bank inside the internal combustion engine. The first control shaft 10 includes a first journal portion 10a, a control eccentric shaft portion 10b, and an eccentric shaft portion 10c. The first journal portion 10a is rotatably supported on a main body of the internal combustion engine. The lower end portion of the first control link 7 is rotatably coupled with the control eccentric shaft portion 10b. One end portion 12a of the second control link 12 is rotatably coupled with the eccentric shaft portion 10c.

A first arm portion 10d has one end coupled with the first journal portion 10a and the other end coupled with the lower end portion of the first control link 7. The control eccentric shaft portion 10b is provided at a position eccentric with respect to the first journal portion 10a by a predetermined amount. A second arm portion 10e has one end coupled with the first journal portion 10a and the other end coupled with the one end portion 12a of the second control link 12.

The eccentric shaft portion 10c is provided at a position eccentric with respect to the first journal portion 10a by a predetermined amount. One end of the arm link 13 is rotatably coupled with the other end portion 12b of the second control link 12. The second control shaft 11 is coupled with the other end of the arm link 13. The arm link 13 and the second control shaft 11 are not movable relative to each other. The second control shaft 11 is rotatably supported in a housing 20, which will be described below, via a plurality of journal portions.

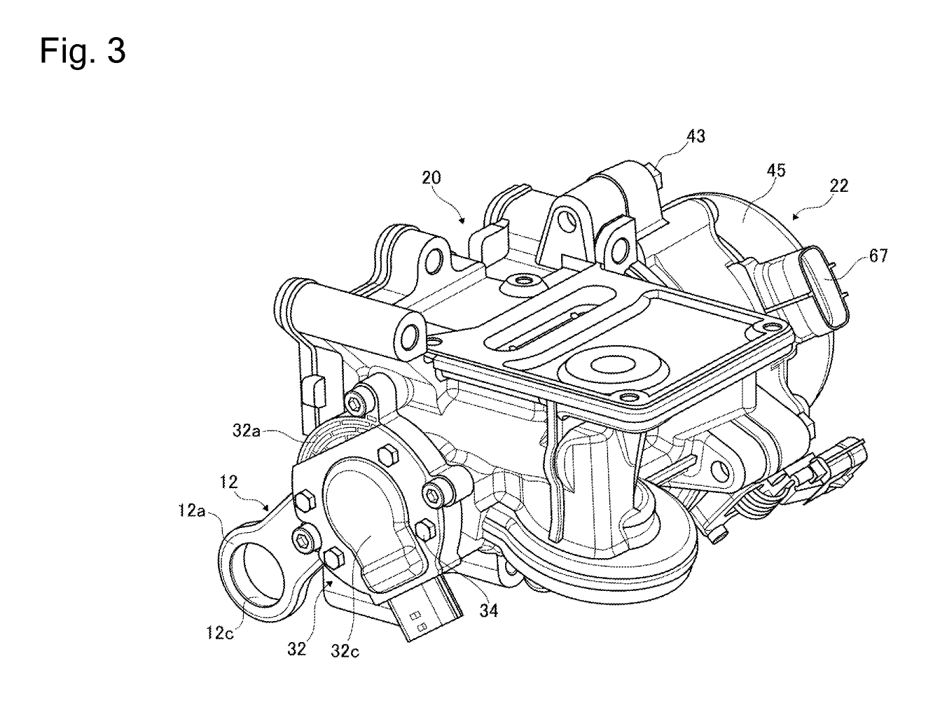

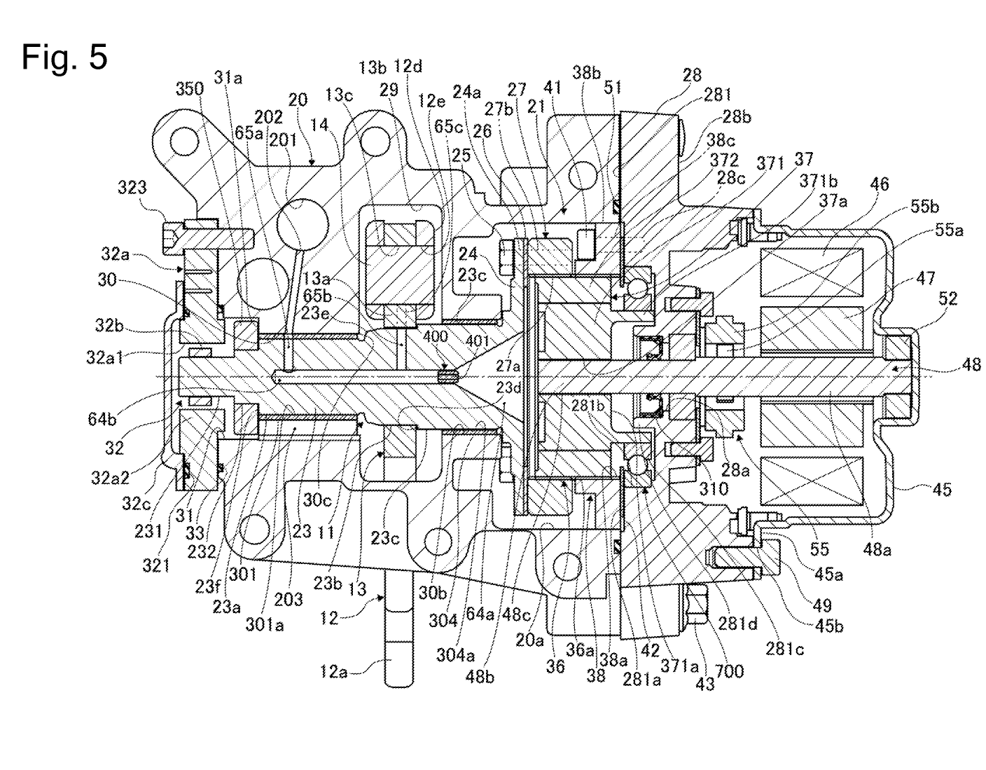

The second control link 12 is prepared in the form of a lever, and the one end portion 12a coupled with the eccentric shaft portion 10c is generally linearly formed. On the other hand, the other end portion 12b with the arm link 13 coupled therewith is formed in a curved manner. An insertion hole 12c is formed through a distal end portion of the one end portion 12a in a penetrating manner (refer to FIG. 3). The eccentric shaft portion 10c is rotatably inserted through the insertion hole 12c. The other end portion 12b includes distal end portions 12d formed into a fork-like shape as illustrated in a cross-sectional view of the actuator illustrated in FIG. 5. A coupling hole 12e is formed at each of the distal end portions 12d. Further, a coupling hole 13c is formed through a protrusion portion 13b of the arm link 13 in a penetrating manner. The coupling hole 13c is generally equal in diameter to the coupling hole 12e. The protrusion portion 13b of the arm link 13 is inserted through between each of the distal end portions 12d formed into the fork-like shape, and a coupling pin 14 is fixedly press-fitted by penetrating through the coupling holes 12e and 13c in this state.

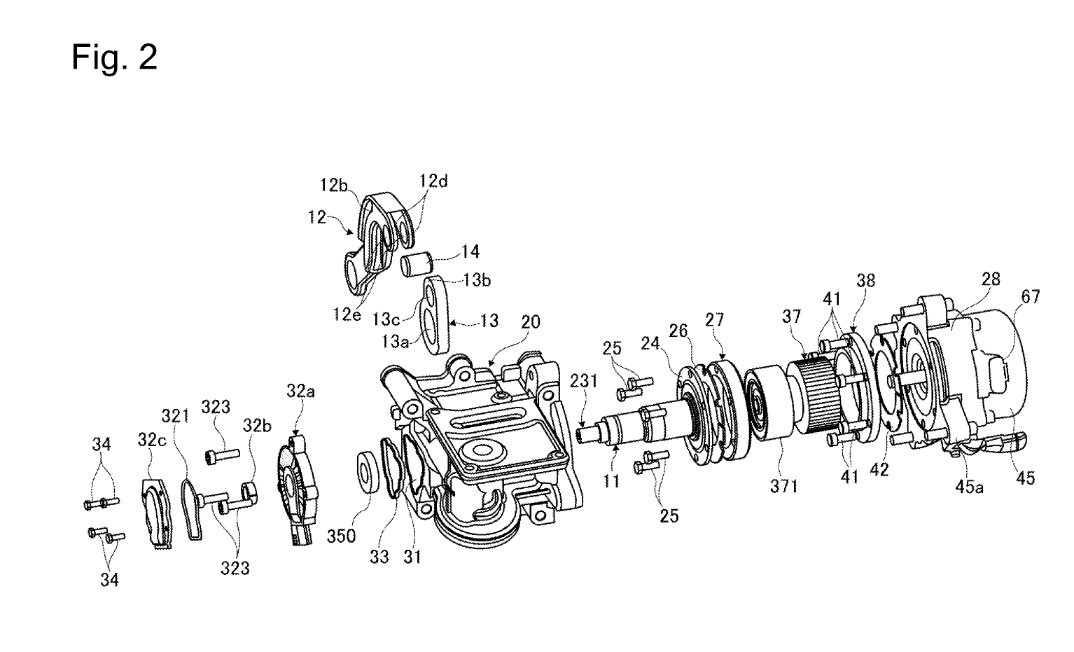

The arm link 13 is formed as a different member from the second control shaft 11 as illustrated in an exploded perspective view of the actuator illustrated in FIG. 2. The arm link 13 is a thick member made from a ferrous metallic material, and includes an annular portion and the protrusion portion 13b. A press-fitting hole 13a is formed through an approximately central position of the annular portion in a penetrating manner. The protrusion portion 13b protrudes toward an outer periphery. A fixation portion 23b, which is formed between each of the journal portions of the second control shaft 11, is press-fitted in the press-fitting hole 13a, and the second control shaft 11 and the arm link 13 are fixed by this press-fitting. The coupling hole 13c is formed through the protrusion portion 13b. The coupling pin 14 is rotatably supported in the coupling hole 13c. A central axis of this coupling hole 13c (a shaft center of the coupling pin 14) is positioned radially eccentrically with respect to a shaft center of the second control shaft 11 by a predetermined amount.

A rotational position of the second control shaft 11 is changed by a torque transmitted from a driving motor 22 via a strain wave gearing speed reducer 21, which is a part of the actuator of the link mechanism for the internal combustion engine. The change in the rotational position of the second control shaft 11 causes a change in an orientation of the second control link 12 and thus a rotation of the first control shaft 10, thereby causing a change in a position of the lower end portion of the first control link 7. This results in a change in an orientation of the lower link 5 and thus a change in a stroke position and a stroke amount of the piston 1 in the cylinder, thereby leading to a change in an engine compression ratio according thereto.

[Configuration of Actuator of Link Mechanism for Internal Combustion Engine]

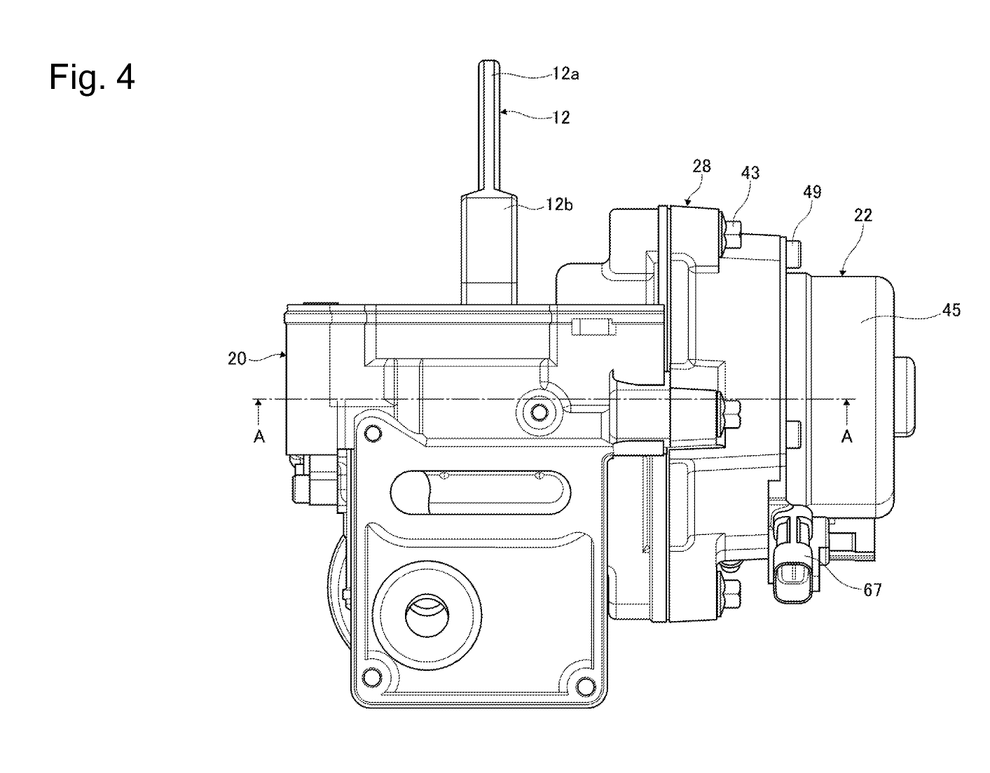

FIG. 2 is the exploded perspective view of the actuator of the link mechanism for the internal combustion engine according to the first embodiment. FIG. 3 is a perspective view of the actuator of the link mechanism for the internal combustion engine according to the first embodiment. FIG. 4 is a left side view of the actuator of the link mechanism for the internal combustion engine according to the first embodiment. FIG. 5 is a cross-sectional view taken along a line A-A in FIG. 4. As illustrated in FIGS. 2 to 5, the actuator of the link mechanism for the internal combustion engine includes the driving motor 22, the strain wave gearing speed reducer 21, the housing 20, and the second control shaft 11. The strain wave gearing speed reducer 21 is attached to a distal end side of the driving motor 22. The housing 20 contains the strain wave gearing speed reducer 21 therein. The second control shaft 11 is rotatably supported on the housing 20.

(Configuration of Driving Motor)

The driving motor 22 is a brushless motor, and includes a bottomed cylindrical motor casing 45, a cylindrical coil 46, a rotor 47, a motor driving shaft 48, and a resolver 55. The coil 46 is fixed to an inner peripheral surface of the motor casing 45. The rotor 47 is rotatably provided inside the coil 46. The motor driving shaft 48 include one end portion 48a fixed to a center of the rotor 47. The resolver 55 detects a rotational angle of the motor driving shaft 48.

The motor driving shaft 48 is rotatably supported by a ball bearing 52 provided at a bottom portion of the motor casing 45. The motor casing 45 includes four boss portions 45a on an outer periphery of a front end thereof. A bolt insertion hole 45b is formed through each of the boss portions 45a in a penetrating manner. A bolt 49 is inserted through the bolt insertion hole 45b.

The resolver 55 includes a resolver rotor 55a and a sensor portion 55b. An outer periphery of the motor driving shaft 48 is fixedly press-fitted in the resolver rotor 55a. The sensor portion 55b detects a multi-toothed target formed on an outer peripheral surface of the resolver rotor 55a. The resolver 55 is provided at a position protruding from an opening of the motor casing 45. The sensor portion 55b is fixed inside a cover 28 with use of two screws, and also outputs a detection signal to a not-illustrated control unit. When the motor casing 45 is attached to the cover 28, the bolts 49 are inserted through the boss portions 45a while an O-ring 51 is interposed between an end surface of the resolver 55 and the cover 28, and the bolts 49 are fastened to male screw portions formed on the driving motor 22 side of the cover 28. By this attachment, the motor casing 45 is fixed to the cover 28. A motor containing chamber, which contains the driving motor 22 by the motor casing 45 and the cover 28, is formed as a drying chamber to which lubricant oil or the like is not supplied.

(Configuration of Second Control Shaft)

The second control shaft 11 includes a shaft portion main body 23 and a fixation flange 24. The shaft portion main body 23 axially extends. The fixation flange 24 has a diameter that increases from the shaft portion main body 23. The second control shaft 11 includes the shaft portion 23 and the fixation flange 24 that are integrally formed from a ferrous metallic material. The shaft main body 23 includes a sensor shaft portion 231 and a retainer shaft portion 232 (refer to FIG. 5). An axially stepped shape is formed on the sensor shaft portion 231, and the sensor shaft portion 231 is positioned on an inner periphery of an angle sensor 32. The retainer shaft portion 232 is larger in diameter than the sensor shaft portion 231, and is fixedly press-fitted in a retainer 350. The retainer 350 is a restriction member that restricts a movement of the second control shaft 11 toward the strain wave gearing speed reducer side in the axial direction. The second control shaft 11 includes a rotor 32b on an outer periphery of the sensor shaft portion 231 (refer to FIG. 5). The rotor 32b functions as a component of the angle sensor 32. Further, the second control shaft 11 includes a small-diameter first journal portion 23a on a distal end portion side, an intermediate-diameter fixation portion 23b, and a large-diameter second journal portion 23c on the fixation flange 24 side on the strain wave gearing speed reducer side with respect to the retainer shaft portion 232. The fixation portion 23b is press-fitted into the press-fitting hole 13a of the arm link 13 from the first journal portion 23a side. Further, a first stepped portion 23d is formed between the fixation portion 23b and the second journal portion 23c. Further, a second stepped portion 23e is formed between the first journal portion 23a and the fixation portion 23b. Further, a third stepped portion 23f is formed between the first journal portion 23a and the retainer shaft portion 232. This third stepped portion 23f serves as a stopper when the retainer shaft portion 232 is press-fitted into the retainer 350, and therefore can facilitate the press-fitting.

When the fixation portion 23b is press-fitted into the press-fitting hole 13a of the arm link 13 from the first journal portion 23a side, an end portion of the press-fitting hole 13a on one side on the second journal portion 23c side abuts against the first stepped portion 23d from the axial direction. By this abutment, the first stepped portion 23d restricts a movement of the arm link 13 to the second journal portion 23c side. On the other hand, the second stepped portion 23e restricts a movement of the second control shaft 11 in the axial direction and to an opposite side from the strain wave gearing speed reducer 21 side by abutting against a stepped hole edge portion 30c of a support hole 30 and a bearing 301 when the shaft portion main body 23 is inserted through an internal race 701 press-fitted in the support hole 30 formed in the housing 20. The shaft portion main body 23 is supported rotatably and slightly axially movably in a first bearing hole 301a of the bearing 301 and a second bearing hole 304a of a bearing 304. In other words, slight spaces are generated between an inner periphery of the first bearing hole 301a and the shaft portion main body 23 and between an inner periphery of the second bearing hole 304a and the shaft portion main body 23. The fixation flange 24 includes six bolt insertion holes 24a formed at even intervals in a circumferential direction of an outer peripheral portion thereof. The second control shaft 11 is coupled with a strain wave gear output shaft member 27, which is internal teeth of the strain wave gearing speed reducer 21, via a thrust plate 26, with six bolts 25 inserted through these bolt insertion holes 24a.

The second control shaft 11 includes an introduction portion, which introduces the lubricant oil press-fed from a not-illustrated oil pump, in a shaft of the second control shaft 11. The introduction portion includes a conical oil chamber 64a and a bottomed axial oil passage 64b. The oil chamber 64a is formed at a center of the fixation flange 24, and the lubricant oil is supplied from the axial oil passage 64b, which will be described below, to the oil chamber 64a. The axial oil passage 64b is formed from the oil chamber 64a along a shaft center direction of the second control shaft. A narrow hole member 400 is press-fitted in an end portion of the axial oil passage 64b on the oil chamber 64a side. A narrow hole 401 penetrating along the shaft center is formed through the narrow hole member 400. The narrow hole member 400 includes the narrow hole 401 formed so as to penetrate along the shaft center. The narrow hole 401 has a smaller area in cross section in a direction perpendicular to the shaft than an area of the axial oil passage 64b in cross section in the direction perpendicular to the shaft, thereby functioning as an orifice. By this configuration, even with the large-diameter axial oil passage 64b formed by being bored from the oil chamber 64a side, an orifice effect can be exerted due to the narrow hole 401 provided near a lubricant oil discharge port on the oil chamber 64a side, and the lubricant oil can be spread in the oil chamber 64a. The lubrication oil supplied to the oil chamber 64a is supplied to the strain wave gearing speed reducer 21, which will be described below. Further, the second control shaft 11 includes a plurality of radial oil passages 65a and 65b, which is in communication with the axial oil passage 64b, in the shaft of the second control shaft 11.

The bearing 301 includes a bearing portion lubricant oil supply oil passage 302 in a radial direction thereof. The bearing portion lubricant oil supply oil passage 302 is in communication with a second lubricant oil supply oil passage 202, which will be described below, and is opened at a position facing the radial oil passage 65a of the second control shaft 11. A radially outer side of the radial oil passage 65a is opened to a clearance between an outer peripheral surface of the first journal portion 23a and the first bearing hole 301a, and supplies the lubricant oil to the first journal portion 23a. Further, a groove that is a groove approximately equal in width to a diameter of the radial oil passage 65a is formed on an outer periphery at an axial position where the radial oil passage 65a is formed, and the lubricant oil supplied to the outer periphery of the first journal portion 23a is guided from an entire circumference to flow into the radial oil passage 65a, thereby being supplied to the axial oil passage 64b. The radial oil passage 65b is in communication with an oil hole 65c formed inside the arm link 13, and supplies the lubricant oil to between an inner peripheral surface of the coupling hole 13c and an outer peripheral surface of the coupling pin 14 via the oil hole 65c.

(Configuration of Housing)

The housing 20 is formed into a generally cubic shape with use of an aluminum allow material. A large-diameter annular opening groove portion 20a is formed at a rear end side of the housing 20. This opening groove portion 20a is closed by the cover 28 via the O-ring 51. The cover 28 includes a motor shaft penetration hole 28a and four boss portions 28b. The motor shaft through-hole 28a penetrates through a central position of the cover 28. The boss portions 28b have diameters that increase toward a radially outer peripheral side. The cover 28 and the housing 20 are fixedly fastened to each other with bolts 43 inserted through bolt insertion holes formed through the boss portions 28b in a penetrating manner.

An opening for the second control link 12 coupled with the arm link 13 is formed on a side surface perpendicular to an opening direction of the opening groove portion 20a. A containing chamber 29 is formed inside the housing 20 with this opening formed therein. The containing chamber 29 serves as a working area of the arm link 13 and the second control link 12. A speed reducer-side through-hole 30b is formed between the opening groove portion 20a and the containing chamber 29. The second journal portion 23c of the second control shaft 11 penetrates through the speed reducer-side through-hole 30b. The support hole 30 is formed on an axial side surface of the containing chamber 29. The first journal portion 23a of the second control shaft 11 penetrates through the support hole 30. The bearing 301 is disposed between the support hole 30 and the first journal portion 23a, and the bearing 304 is disposed between the support hole 30b and the second journal portion 23c.

A retainer containing hole 31 is formed at an end portion of the support hole 30 on the angle sensor 32 side. The retainer containing hole 31 is larger in diameter than an opening of the support hole 30. The housing 20 includes a stepped surface 31a between the opening of the support hole 30 on the angle sensor 32 side and the retainer containing hole 31. The stepped surface 31a is formed in a direction generally perpendicular to the second control shaft 11. The retainer 350 restricts the movement of the second control shaft 11 to the strain wave gearing speed reducer side in the axial direction by abutting against the stepped surface 31a. The housing 20 includes a first lubricant oil supply oil passage 201 and a second lubricant oil supply oil passage 202 in the housing 20. The first and second lubricant oil supply oil passages 201 and 202 introduce the lubricant oil pressure-fed from the not-illustrated oil pump. The first lubricant oil supply oil passage 201 extends in the direction generally perpendicular to the second control shaft 11. The second lubricant oil supply oil passage 202 connects the first lubricant oil supply oil passage 201 and the support hole 30 to each other. The housing 20 includes a lubricant oil return flow oil passage 203. The lubricant oil return flow oil passage 203 is in communication with the retainer containing hole 31, and also returns the lubricant oil to the containing chamber 29 side.

(Configuration of Angle Sensor)

The angle sensor 32 includes a sensor holder 32a attached so as to close the retainer containing hole 31 from outside the housing 20. The sensor holder 32a includes a through-hole 32a1 and a flange portion 32a2. A detection coil 32a2 is disposed on an inner peripheral portion of the through-hole 32a1. The flange portion 32a2 is used to fix the sensor holder 32a to the housing 20 by a bolt. A seal ring 33 is provided between the sensor holder 32a and the housing 20, and ensures liquid tightness between the retainer containing hole 31 and the outside. Further, the angle sensor 32 includes a sensor cover 32c on an outer peripheral side of the sensor holder 32a. The sensor cover 32c closes the through-hole 32a1. A seal ring 323 is provided between the sensor cover 32c and the sensor holder 32a, and ensures liquid tightness between the retainer containing hole 31 and the through-hole 32a1 and the outside.

The sensor shaft portion 231 is inserted in the through-hole 32a1. The rotor 32b is attached to the outer periphery of the sensor shaft portion 231. The rotor 32b is a generally elliptic component. The angle sensor 32 detects a change in a distance set between an inner periphery of the through-hole 32a1 and the rotor 32b due to a rotation of the rotor 32b based on a change in inductance of the detection coil. By this detection, the angle sensor 32 detects a rotation position of the rotor 32b, i.e., a rotational angle of the second control shaft 11. The angle sensor 32 is a so-called resolver sensor as described above, and outputs rotational angle information to the not-illustrated control unit that detects an engine operation state.

(Configuration of Strain Wave Gearing Speed Reducer)

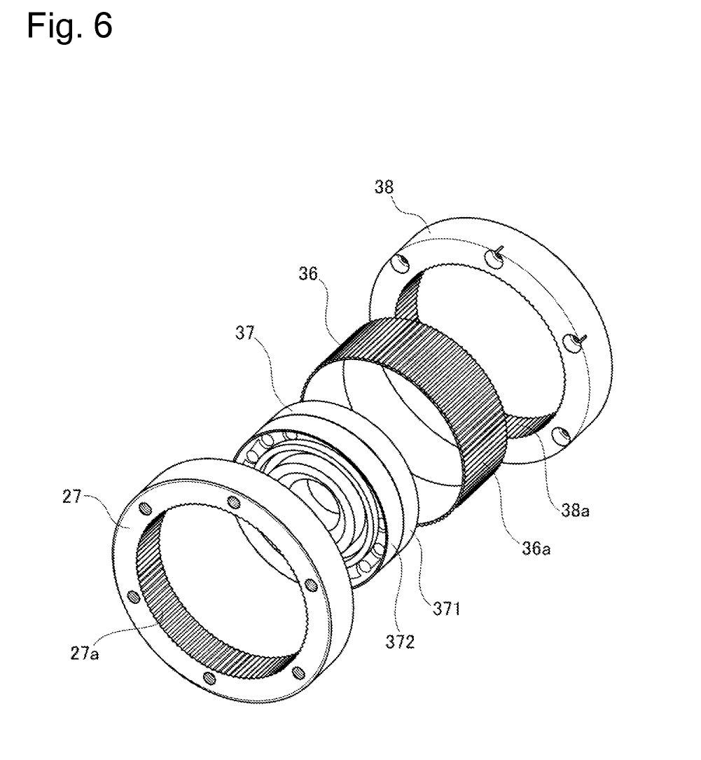

FIG. 6 is an exploded perspective view of the strain wave gearing speed reducer according to the first embodiment. The strain wave gearing speed reducer 21 is a harmonic drive (registered trademark) speed reducer, and each component thereof is contained in the opening groove portion 20a of the housing 20 that is closed by the cover 28. The strain wave gearing speed reducer 21 includes an annular first strain wave gear output shaft member 27, a flexible external gear 36, a wave generator 37, and a second strain wave gear fixation shaft member 38. The first strain wave gear output shaft member 27 is fixed to the fixation flange 24 of the second control shaft 11 with use of a bolt, and includes a plurality of internal teeth 27a formed on an inner periphery thereof. The flexible external gear 36 is disposed on a radially inner side of the first strain wave gear output shaft member 27, is deflectably deformable, and includes external teeth 36a meshed with the internal teeth 27a on an outer peripheral surface thereof. The wave generator 37 is elliptically formed, and an outer peripheral surface thereof is slidably moved along an inner peripheral surface of the flexible external gear 36. This occurs because, since the flexible external gear 36 is provided deflectably deformably, the flexible external gear 36 is deformed as if being twisted due to an input from the wave generator or a reverse input from the engine side to the strain wave gear output shaft member 27 that is applied to the arm link 13, and the external teeth 36a of the flexible external gear 36 is deformed obliquely with respect to the axial direction due to this twist, whereby the second control shaft 11 coupled with the strain wave gear output shaft member 27 fitted thereto is moved in a thrust direction. The second strain wave gear fixation shaft member 38 is disposed on a radially outer side of the flexible external gear 36, and includes internal teeth 38a meshed with the external teeth 36a on an inner peripheral surface thereof.

Male screw holes 27b, which serve as respective nut portions of the bolts 25, are formed at positions at even intervals in the circumferential direction on an outer peripheral side of the first strain wave gear output shaft member 27. The flexible external gear 36 is made from a metallic material, and is a deflectably deformable thin cylindrical member. The number of teeth of the external teeth 36a of the flexible external gear 36 is equal to the number of teeth of the internal teeth 27a of the first strain wave gear output shaft member 27.

The wave generator 37 includes an elliptic main body portion 371 and a ball bearing 372. The ball bearing 372 permits a relative rotation between an outer periphery of the main body portion 371 and an inner periphery of the flexible external gear 36. A through-hole 37a is formed at a center of the main body portion 371. A serration is formed on an inner periphery of the through-hole 37a, and is coupled with a serration formed on an outer periphery of the other end portion 48b of the motor driving shaft 48 by serration coupling. This coupling may be achieved by coupling using a keyway or spline coupling, and is not especially limited. The wave generator 37 includes a cylindrical portion 371b on a driving motor-side side surface 371a of the main body portion 371. The cylindrical portion 371b is provided to extend to the driving motor side so as to surround an outer periphery of the through-hole 37a. This cylindrical portion 371b has a perfect circular shape in cross section, and an outer periphery of the cylindrical portion 371b is set to a smaller diameter than a minor axis of the main body portion 371.

A flange 38b is formed on an outer periphery of the second strain wave gear fixation shaft member 38. The flange portion 38b is used for fastening the second strain wave gear fixation shaft member 38 to the cover 28. Six bolt through-holes 38c are formed through the flange 38b in a penetrating manner. The second strain wave gear fixation shaft member 38 and a second thrust plate 42 are fixedly fastened to the cover 28 by placing the second thrust plate 42 between the second strain wave gear fixation shaft member 38 and the cover 28 and inserting bolts 41 through the bolt insertion holes 38c. The second thrust plate 42 is made from a ferrous metallic material as wear-resistant as or more wear-resistant than the flexible external gear 36. Due to this configuration, the actuator prevents the cover 28 from being worn due to a thrust force generated on the flexible external gear 36, and also regulates an axial position of a ball bearing 700, which will be described below. Further, the second thrust plate 42 is an annular disk-like member, and is formed in such a manner that an inner peripheral-side edge portion 42a thereof is located on the shaft center side with respect to an inner periphery of an outer race 702 of the ball bearing 700, which will be described below. Details thereof will be described below. The number of teeth of the internal teeth 38a of the second strain wave gear fixation shaft member 38 is greater than the number of teeth of the external teeth 36a of the flexible external gear 36 by two. Therefore, the number of teeth of the internal teeth 38a of the second strain wave gear fixation shaft member 38 is greater than the number of teeth of the internal teeth 27a of the first strain wave gear output shaft member 27 by two. The speed reduction ratio of the strain wave gearing speed reduction mechanism is determined according to this difference between the numbers of teeth, and therefore a significantly high speed reduction ratio can be acquired.

(Regarding Support Structure of Rotational Member)

The cover 28 includes female screw portions 28c, a plate containing portion 281a, a bearing containing portion 281b, and a cylindrical seal containing portion 281d. The bolts 41 are threadably engaged with the female screw portions 28c. The plate containing portion 281a has a depth approximately equal to a thickness of the second thrust plate 42, and houses the second thrust plate 42 therein. The bearing containing portion 281b is a bottomed cylindrical stepped portion formed by being bent from the plate containing portion 281a to the driving motor 22 side. The seal containing portion 281d stands on the wave generator side in the axial direction at a radially inner position of a bottom surface 281c of the bearing containing portion 281b. The above-described motor shaft through-hole 28a is formed on a more radially inner side than the seal containing portion 281d. In other words, the bearing containing portion 281b is an annular recessed portion recessed from the end surface 281 of the cover 28 on the strain wave gearing speed reducer 21 side to one end side in a direction of a rotational axis of the wave generator 37.

The open-type ball bearing 700 is contained in the bearing containing portion 281b. The ball bearing 700 is a four-point contact roller bearing that can receive a load in the thrust direction. The ball bearing 700 includes an inner race 701, balls 703, and the outer race 702. The inner race 701 supports a cylindrical portion 371b, which will be described below. The balls 703 are rolling members. The outer race 702 is held by the housing 20. An axial thickness of the ball bearing 700 is approximately equal to an axial depth of the bearing containing portion 281b. Further, an outer diameter of the ball bearing 700 is set to a larger diameter than an outer diameter of the ball bearing 52, and therefore a sufficient bearing capacity is ensured. The outer race 702 is contained in the bearing containing portion 281b. An end surface of the outer race 702 on the strain wave gearing speed reducer 21 side is in abutment with or slightly spaced apart from the second thrust plate 42, and an end surface of the outer race 702 on the driving motor 22 side is in abutment with the bottom surface 281c. Due to this configuration, the support structure regulates a position of the outer race 702 in an axial direction of the ball bearing 700 and in both directions on the strain wave gearing speed reducer 21 side and the driving motor 22 side. Further, the bearing containing portion 281b is provided on the driving motor 22 side of the wave generator 37. In other words, the support structure supports the ball bearing 700 at a position further close to the driving motor 22, thereby preventing or reducing a deformation of the motor driving shaft 48 and preventing or cutting down an increase in an axial dimension thereof toward the second control shaft 11 side.

The outer diameter of the outer race 702 is set to a larger diameter than inner diameters of the first and second strain wave gear fixation shaft members 27 and 38. Further, an inner diameter of the outer race 702 is set to a smaller diameter than an inner diameter of the flexible external gear 36. An outer peripheral side of the cylindrical portion 371b provided so as to extend from the main body portion 371 of the wave generator 37 is fixed (press-fitted) to an inner periphery of the inner race of the ball bearing 700. Being fixed here is not limited to being press-fitted, and also includes, for example, being axially positionally regulated with use of a step or a snap ring. Due to this configuration, the motor driving shaft 48 is supported by the ball bearing 52 provided between the motor driving shaft 48 and the motor casing 45, and is also supported by the ball bearing 700 via the main body portion 371 and the cylindrical portion 371b.

The second control shaft 11 is supported at the first journal portion 23a and the second journal portion 23c rotatably relative to the housing 20. An alternate load is input from a primary motion system of the internal combustion engine to this second control shaft 11. Therefore, the speed should be slowed down by the strain wave gearing speed reducer 21 to allow the second control shaft 11 to rotate against this alternate load. However, an axial load is generated on this strain wave gearing speed reducer 21 when the speed is slowed down, and therefore is also applied to the second control shaft 11. Further, an axial load due to a tilt of the arm link 13 is applied. This occurs because, since the flexible external gear 36 is provided deflectably deformably, the flexible external gear 36 is deformed as if being twisted due to an input from the wave generator 37 or a reverse input from the engine side to the strain wave gear output shaft member 27 that is applied to the arm link 13, and the external teeth 36a of the flexible external gear 36 is deformed obliquely with respect to the axial direction due to this twist, whereby the second control shaft 11 coupled with the strain wave gear output shaft member 27 fitted thereto is moved in the thrust direction. If the second control shaft 11 is excessively axially moved at this time, this movement may cause an unnecessary load to be applied to the strain wave gearing speed reducer 21, thereby leading to a reduction in durability. Therefore, the second control shaft 11 is provided with the retainer 350 including the restriction surface 501 oriented to the strain wave gearing speed reducer side in the axial direction, and the housing 20 side is provided with the stepped surface 31a that abuts against the restriction surface 501. Due to this provision, the present configuration is allowed to function as a restriction mechanism that restricts the excessive movement of the second control shaft 11 toward the strain wave gearing speed reducer side.

(Configuration of Seal Portion)

The support structure includes the seal containing portion 281d on the radially inner side of the cylindrical portion 371b. The seal containing portion 281d is smaller in diameter than an inner peripheral surface of the cylindrical portion 371b. A seal member 310 is provided between an inner periphery of the seal containing portion 281d and the outer periphery of the motor driving shaft 48. The seal member 310 liquid-tightly seals between the opening groove portion 20a containing the strain wave gearing speed reducer 21 and the driving motor 22. The seal containing portion 281d is erected on the radially inner side of the cylindrical portion 371b. In other words, the seal containing portion 281d is formed so as to overlap the cylindrical portion 371b and the ball bearing 700 as viewed from the radial direction.

(Regarding Supply of Lubricant Oil)

The lubricant oil supplied from the first lubricant oil supply oil passage 201 flows into the axial oil passage 64b via the second lubricant oil supply oil passage 202, the bearing portion lubricant oil supply oil passage 302, and the radial oil passage 65a. The lubricant oil delivered to the axial oil passage 64b is effectively spread in the oil chamber 64a due to the orifice effect because passing through the narrow hole 401 of the narrow hole member 400. At this time, the lubricant oil is also supplied to the space between the first journal portion 23a of the second control shaft 11 and the inner periphery of the bearing 301 when flowing from the bearing portion lubricant oil supply oil passage 302 to the radial oil passage 65a. The lubricant oil supplied to this space flows to the arm link 13 side, and also flows to the angle sensor 32 side. The lubricant oil supplied to between the side surface of the retainer 350 and the stepped surface 31a is returned from the lubricant oil return flow oil passage 203 provided at a lower side in FIG. 5 to the containing chamber 29 side.

(Regarding Retention of Lubricant Oil)

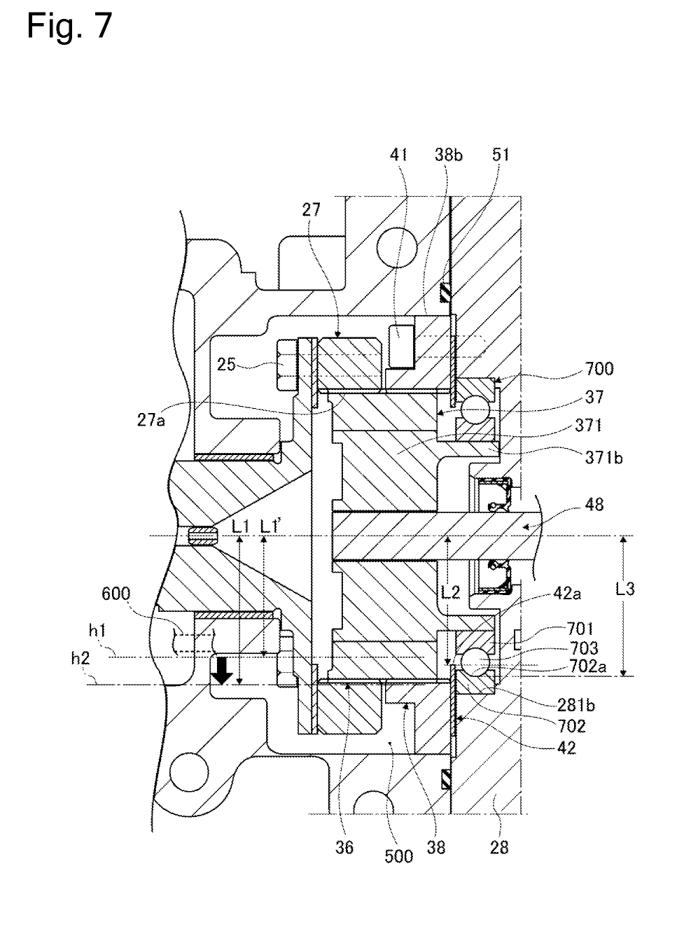

Next, retention of the lubricant oil will be descried. FIG. 7 is a cross-sectional view of main portions near the strain wave gearing speed reducer according to the first embodiment. The strain wave gearing speed reducer 21 is contained and a strain wave gearing speed reducer containing chamber 500 is also defined in the opening groove 20a formed in the housing 20. An opening of the strain wave gearing speed reducer containing chamber 500 is closed by the cover 28. The lubricant oil is stored in this strain wave gearing speed reducer containing chamber 500 so as to keep a predetermined oil level height h1 when the vehicle is running on a flatland. A height of h1 in a direction of gravitational force is located at a higher position than a lower end portion of the flexible external gear 36 of the strain wave gearing speed reducer 21 and a lower end portion of the inner periphery of the outer race 702 of the ball bearing 700 in the direction of gravitational force when the vehicle is running on the flatland. Due to this configuration, the actuator achieves the supply of the lubricant oil to the strain wave gearing speed reducer 21 and the ball bearing 700, and thus improvement of the durability.

A drain hole 600 is formed at the housing 20 to maintain this predetermined oil level height h1. Even when the lubricant oil is excessively supplied, the actuator allows the lubricant oil to be discharged from the drain hole 600, thereby preventing or cutting down an increase in friction due to excessive lubrication. Now, L1 and L3 are defined to represent a length in the direction of gravitational force from the shaft center on the flatland to a lower end of the drain hole 600, and a length in the direction of gravitational force from the shaft center to a lower end 702a of a rolling surface near a contact surface where the outer race 702 of the ball bearing 700 and the balls 703 are in contact with each other, respectively. The outer race 702 and the balls 703 are in contact with each other at two portions, and these contact positions are regarded as approximately the same position as the lower end 702a of the rolling surface although being located on a slightly upper side with respect to the lower end 702a of the rolling surface in the direction of gravitational force. The drain hole 600 is formed at such a position that L1 is shorter than L3.

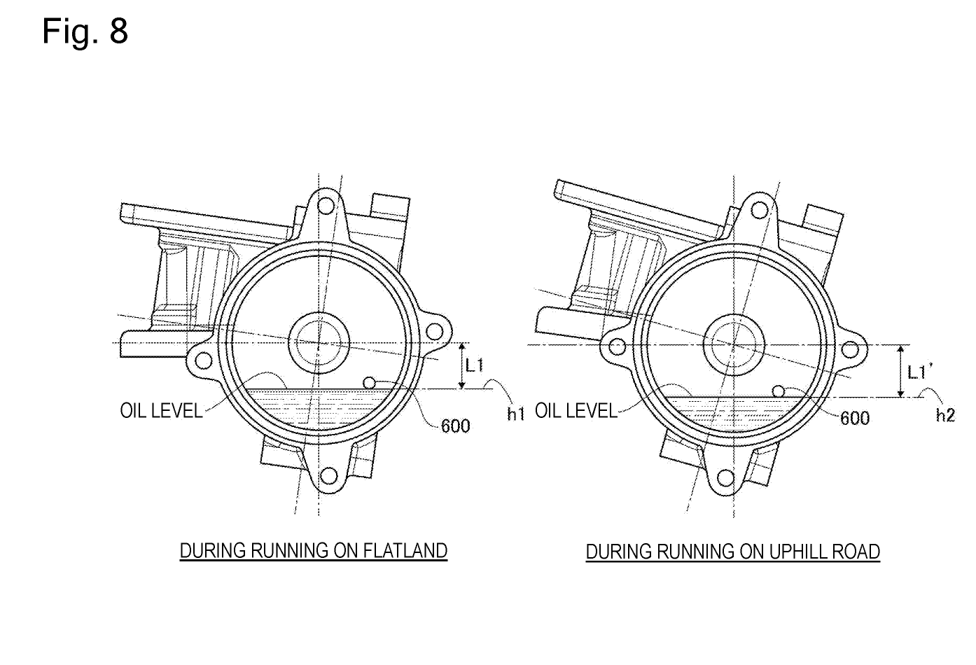

FIG. 8 schematically illustrates a change in the oil level height between running on the flatland and running on an uphill road according to the first embodiment when the actuator is mounted on the vehicle. When the running is switched from the running on the flatland to the running on the uphill road, the position of the drain hole 600 is also changed according to a slope of the uphill road. Then, the length from the shaft center to the lower end of the drain hole 600 in the direction of gravitational force increases such that L1′ is longer than L1, and an oil level height h2 is located on a lower side with respect to the lower end 702a of the rolling surface in the direction of gravitational force. At this time, exceeding L1′ over L3 makes it impossible to sufficiently supply the lubricant oil to the lower end 702a of the rolling surface. This leads to such a problem that the insufficiency of the supply of the lubricant oil to the ball bearing 700 especially with a large engine output generated, like on the uphill road, results in a reduction in the durability of the ball bearing 700.

With the aim of solving this problem, in the first embodiment, the second thrust plate 42 is formed in such a manner that L2 is shorter than L3 and L2 is longer than L1, when L2 is defined to represent a length from the shaft center to the inner peripheral-side edge portion 42a of the second thrust plate 42. Due to this configuration, when the vehicle is running on the flatland, the predetermined oil level height h1 is located on an upper side with respect to the inner peripheral-side edge portion 42a, and therefore the lubricant oil can be supplied to a region surrounded by the bearing containing portion 281b and the second thrust plate 42. On the other hand, when the vehicle is running on the uphill road, even with the oil level height being h2 and being located on a lower side with respect to the inner peripheral-side edge portion 42a, the inner peripheral-side edge portion 42a is kept at a higher position than the lower end 702a of the rolling surface, and therefore the ball bearing 700 can be lubricated by the stored lubricant oil.

### Advantageous Effects

(1) The first embodiment is the actuator configured to be used for the link mechanism for the internal combustion engine and configured to rotate the second control shaft 11 (a control shaft) for changing the orientation of the link mechanism for the internal combustion engine. The actuator includes the strain wave gearing speed reducer 21 configured to decrease the rotational speed of the driving motor 22 (an electric motor) and transmit the rotation thereof to the second control shaft 11, the housing 20 including the strain wave gearing speed reducer containing chamber 500 (a containing chamber) in which the driving motor 22 is fixed and the strain wave gearing speed reducer 21 is also contained, and the axial oil passage 64b (a communication passage) provided at the housing 20 or the second control shaft 11 and establishing the communication between the strain wave gearing speed reducer containing chamber 500 and the lubricant oil passage of the internal combustion engine. The strain wave gearing speed reducer 21 includes the wave generator 37 having the elliptic outline coupled with the motor driving shaft 48 (an output shaft) of the driving motor 22, the flexible external gear 36 including the external teeth 36a on the outer periphery thereof and the cylindrical portion inserted through the outer peripheral side of the wave generator 37 and configured to transmit the rotation of the cylindrical portion to the second control shaft 11, and the first strain wave gear output member 27 and the second strain wave gear fixation shaft member 38 (an internal gear) fixed to the housing 20 and including the internal teeth 27a meshed with the flexible external gear 36. The actuator includes the ball bearing 700 (a roller bearing) provided on the radially inner side with respect to the flexible external gear 36. The ball bearing 700 includes the inner race 701 held by one of the housing 20 and the wave generator 37, the outer race 702 held by the other of the housing 20 and the wave generator 37, and the balls 703 that are a rolling member between the inner race 701 and the outer race 702. The actuator further includes the second thrust plate 42 and the bearing containing portion 281b (a holding mechanism) provided at the housing 20 and capable of holding the lubricant oil on the radially inner side with respect to the outer race 702.

Therefore, the first embodiment can secure the lubricant oil to the ball bearing 700, thereby improving a wear-resistant performance of the ball bearing 700 holding the wave generator 37.

(2) The housing 20 includes the drain hole 600 (a discharge oil passage) capable of discharging the lubricant oil from the strain wave gearing speed reducer containing chamber 500. The lower end portion of the opening portion of the drain hole 600 to the strain wave gearing speed reducer containing chamber 500 in the direction of gravitational force on the flatland road is positioned at the upper side in the direction of gravitational force with respect to the inner peripheral-side edge portion 42a of the second thrust plate 42.

Therefore, when the vehicle is running on the flatland, the first embodiment can allow the oil level to be located on the upper surface with respect to the inner peripheral-side edge portion 42a of the second thrust plate 42, thereby storing the lubricant oil on the ball bearing 700 side of the second thrust plate 42.

(3) The lower end portion of the opening portion of the drain hole 600 to the strain wave gearing speed reducer containing chamber 500 in the direction of gravitational force on the flatland road is positioned at the upper side in the direction of gravitational force with respect to the lower end portion of the flexible external gear 36 in the direction of gravitational force. Therefore, when the vehicle is running on the flatland, the first embodiment can allow the lubricant oil to be constantly supplied to the flexible external gear 36, thereby improving the durability of the flexible external gear 36.
(4) The second thrust plate 42 includes the bottom surface 281c of the bearing containing portion 281b. The bottom surface 281c is the extension portion provided at the housing 20. The extension portion faces one side of the ball bearing 700 in the rotational axis direction, and extends radially inward beyond the inner diameter of the outer race 702 with respect to the outer race 702. The second thrust plate 42 further includes the inner peripheral-side edge portion 42a (a plate member) facing the other side of the ball bearing 700 in the rotational axis direction and extending radially inward beyond the inner diameter of the outer race 702 with respect to the outer race 702.

Therefore, the first embodiment can hold the lubricant oil in the portion where the ball bearing 700 is contained.

(5) The ball bearing 700 is the open-type roller bearing. In other words, the first embodiment ensures a lubrication performance, and therefore allows an inexpensive bearing to be employed instead of an expensive bearing such as a bearing sealingly containing lubricant oil.
(6) The second thrust plate 42 is provided abuttably in the axial direction of the flexible external gear 36.

Due to this configuration, the first embodiment can prevent the cover 28 from being worn due to the thrust force generated on the flexible external gear 36, and also regulate the axial position of the ball bearing 700 and store the lubricant oil.

(7) The second thrust plate 42 is formed into the disk-like shape. Therefore, even when the vehicle rolls, the first embodiment can maintain the height of the inner peripheral-side edge portion 42a, thereby stably storing the lubricant oil.
(8) The second thrust plate 42 is fixedly fastened to the housing 20 together with the strain wave gear fixation shaft member 38.

Therefore, the first embodiment can allow these components to be mounted by one process, thereby ensuring facilitation of assembling.

### Second Embodiment

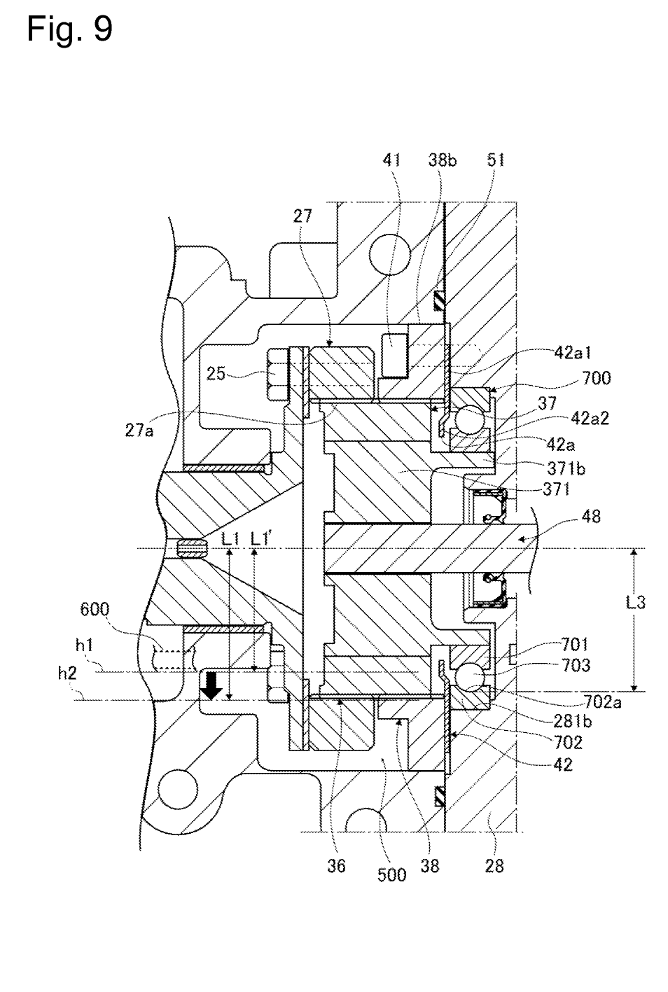

Next, a second embodiment will be described. The second embodiment has a basic configuration similar to the first embodiment, and therefore will be described focusing on only differences therefrom. FIG. 9 is a cross-sectional view of main portions near a strain wave gearing speed reducer according to the second embodiment. In the first embodiment, the second thrust plate 42 is formed as the flat-plate annular member. On the other hand, the second embodiment is different from the first embodiment in terms of the second thrust plate 42 including a step on the inner peripheral side thereof. The second thrust plate 42 according to the second embodiment includes a first disk portion 42a1 and a second disk portion 42a2. The first disk portion 42a1 is fastened to the housing 20 together with the second strain wave gear fixation shaft member 38. The second disk portion 42a2 is formed into a stepped shape from around the inner periphery of the outer race 702 on an inner peripheral side of the first disk portion 42a. The second disk portion 42a2 is set in a direction away from the inner race 701 in the axial direction. Due to this configuration, the actuator can avoid a contact of the inner race 701 with the second thrust plate 42, thereby eliminating or reducing resistance against the rotation. Further, the second disk portion 42a2 is set in the direction away from the inner race 701 in the axial direction, whereby the actuator can increase a volume capable of storing the lubricant oil therein.

### Third Embodiment

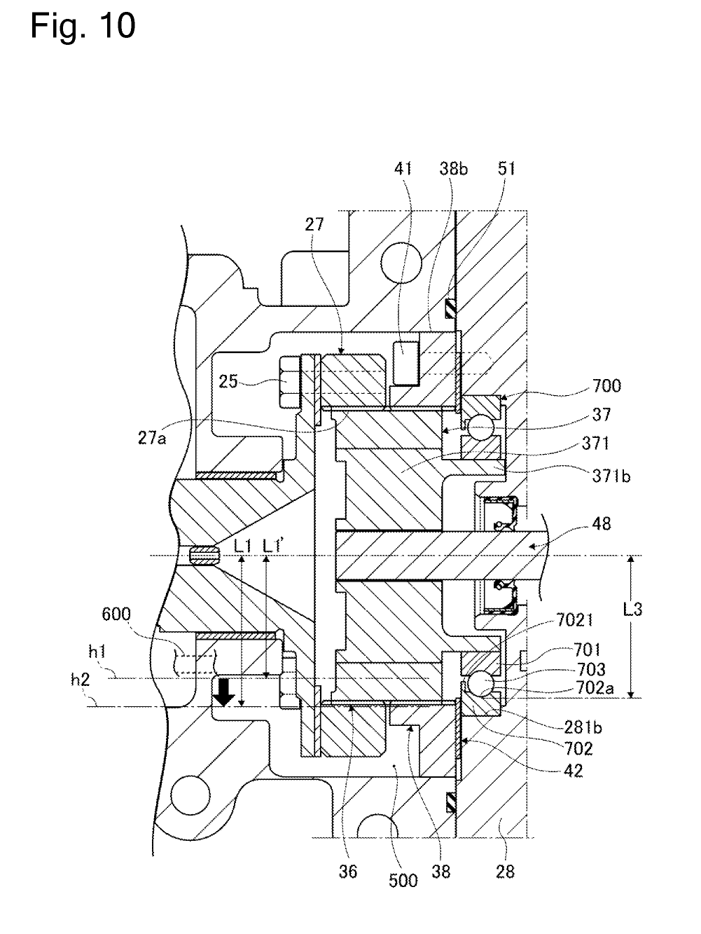

Next, a third embodiment will be described. The third embodiment has a basic configuration similar to the first embodiment, and therefore will be described focusing on only differences therefrom. FIG. 10 is a cross-sectional view of main portions near a strain wave gearing speed reducer according to a third embodiment. In the first embodiment, the lubricant oil is stored in the space defined by the housing 20 and the second thrust plate 42. On the other hand, the third embodiment is different from the first embodiment in terms of provision of an extension portion 7021 extending toward the inner race at an end portion of the outer race 702 of the ball bearing 700 on the strain wave gearing speed reducer 21 side and storage of the lubricant oil in the ball bearing 700. The actuator can store the lubricant oil in the ball bearing 700 regardless of the position of the inner peripheral-side end portion 42a of the second thrust plate 42.

### Fourth Embodiment

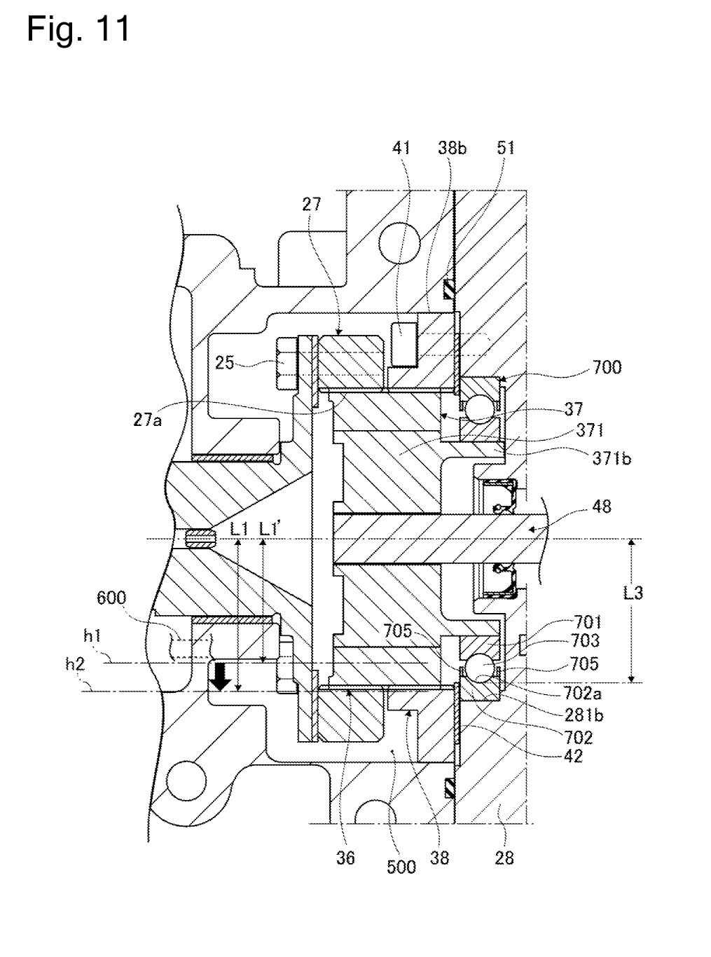

Next, a fourth embodiment will be described. The fourth embodiment has a basic configuration similar to the first embodiment, and therefore will be described focusing on only differences therefrom. FIG. 11 is a cross-sectional view of main portions near a strain wave gearing speed reducer according to a fourth embodiment. In the first embodiment, the lubricant oil is stored with use of the second thrust plate 42. On the other hand, the third embodiment is different from the first embodiment in terms of provision of seal members 705 at both axial end portions of the outer race 702 of the ball bearing 700 on the inner peripheral side thereof. These seal members 705 have a space between the seal members 705 and the inner race 701 on inner peripheral sides thereof, and allow the lubricant oil to flow into the ball bearing 700. The actuator can store the lubricant oil in the ball bearing 700 regardless of the position of the inner peripheral-side end portion 42a of the second thrust plate 42.

### OTHER EMBODIMENTS

Having described the present invention based on the first to fourth embodiments thereof, the specific configuration of each invention is not limited to the first to fourth embodiments, and the present invention also includes a design modification and the like thereof made within a range that does not depart from the spirit of the present invention if any.

For example, in the embodiments, the present actuator of the link mechanism for the internal combustion engine is employed for the mechanism that makes the compression ratio of the internal combustion engine variable, but the present actuator may be employed for a link mechanism of a variable valve actuating mechanism of an internal combustion engine that makes variable an operating characteristic of an intake valve or a discharge valve like, for example, Japanese Patent Application Public Disclosure No. 2009-150244.

Further, in the first to fourth embodiments, the number of teeth of the external teeth 36a of the flexible external gear 36 is set to the same number as the number of teeth of the internal teeth 27a of the first strain wave gear output shaft member 27, but the speed reduction ratio may be adjusted by making a difference in the number of teeth. In this case, the rotation of the cylindrical portion of the flexible external gear 36 will be transmitted to the second control shaft 11 at a speed reduction ratio due to the difference in the number of teeth between the number of teeth of the external teeth 36a and the number of teeth of the internal teeth 27a.

In the following description, technical ideas recognizable from the above-described embodiments will be described.

One aspect is an actuator configured to be used for a link mechanism for an internal combustion engine and configured to rotate a control shaft for changing an orientation of the link mechanism for the internal combustion engine. The actuator includes a strain wave gearing speed reducer configured to decrease a rotational speed of an electric motor and transmit a rotation thereof to the control shaft, a housing including a containing chamber in which the electric motor is fixed and the strain wave gearing speed reducer is also contained, and a communication passage provided at the housing or the control shaft and establishing communication between the containing chamber and a lubricant oil passage of the internal combustion engine. The strain wave gearing speed reducer includes a wave generator having an elliptic outline coupled with an output shaft of the electric motor, a flexible external gear including an external tooth on an outer periphery thereof and a cylindrical portion inserted through an outer peripheral side of the wave generator and configured to transmit a rotation of the cylindrical portion to the control shaft, and an internal gear fixed to the housing and including an internal tooth meshed with the flexible external gear. The actuator includes a roller bearing including an inner race held by one of the housing and the wave generator, an outer race held by the other of the housing and the wave generator, and a rolling member between the inner race and the outer race, and a holding mechanism provided at the roller bearing or the housing and capable of holding the lubricant oil in the roller bearing on a radially inner side with respect to the outer race.

In another preferable configuration, in the above-described configuration, the housing includes a discharge oil passage capable of discharging the lubricant oil from the containing chamber. A lower end portion of an opening portion of the discharge oil passage to the containing chamber in a direction of gravitational force on a flatland road is positioned at an upper side in the direction of gravitational force with respect to the holding mechanism.

In further another preferable configuration, in any of the above-described configurations, the lower end portion of the opening portion of the discharge oil passage to the containing chamber in the direction of gravitational force on the flatland road is positioned at an upper side in the direction of gravitational force with respect to a lower end portion of the flexible external gear in the direction of gravitational force.

In further another preferable configuration, the holding mechanism includes an extension portion provided at the housing. The extension portion faces one side of the roller bearing in a rotational axis direction, and extends radially inward beyond an inner diameter of the outer race with respect to the outer race. The holding mechanism further includes a plate member facing the other side of the roller bearing in the rotational axis direction and extending radially inward beyond the inner diameter of the outer race with respect to the outer race.

In further another preferable configuration, the roller bearing is an open-type roller bearing.

In further another preferable configuration, the plate member is provided abuttably in an axial direction of the flexible external gear.

In further another preferable configuration, the plate member includes a portion axially facing the inner race of the roller bearing. This facing portion is formed into a stepped shape in a direction away from the inner race.

In further another preferable configuration, the plate member is formed into a disk-like shape.

In further another preferable configuration, the plate member is fixedly fastened to the housing together with the internal gear.

In further another preferable configuration, the holding mechanism is an extension portion integrally provided at the outer race of the roller bearing and extending from a radially inner side of the outer race toward the inner race of the roller bearing.

In further another preferable configuration, the holding mechanism is a seal member attached to the outer race of the roller bearing and forming a space between the seal member and the inner race of the roller bearing.

Further, from another aspect, one possible configuration is an actuator configured to be used for a link mechanism for an internal combustion engine and configured to rotate a control shaft for changing an orientation of the link mechanism for the internal combustion engine. The actuator includes a strain wave gearing speed reducer configured to decrease a rotational speed of an electric motor and transmit a rotation thereof to the control shaft, a housing including a containing chamber in which the electric motor is fixed and the strain wave gearing speed reducer is also contained, and a communication passage provided at the housing or the control shaft and establishing communication between the containing chamber and a lubricant oil passage of the internal combustion engine. The strain wave gearing speed reducer includes a wave generator having an elliptic outline coupled with an output shaft of the electric motor, a flexible external gear including an external tooth on an outer periphery thereof and a cylindrical portion inserted through an outer peripheral side of the wave generator and configured to transmit a rotation of the cylindrical portion to the control shaft, an internal gear fixed to the housing and including an internal tooth meshed with the flexible external gear, and a roller bearing including an inner race held by the wave generator, an outer race held by the housing, and a rolling member between the inner race and the outer race. The actuator includes a bearing containing portion formed in the housing. The bearing containing portion is recessed to one end side in a rotational axis direction of the wave generator, and holds the outer race. The actuator further includes a plate member fixed to the roller bearing or the housing. The plate member faces the other end side of the outer race in the rotational axis direction of the wave generator, and extends to a radially inner side with respect to the outer race.

Preferably, in the above-described configuration, the housing includes a discharge oil passage capable of discharging the lubricant oil from the containing chamber. A lower end portion of an opening portion of the discharge oil passage to the containing chamber in a direction of gravitational force on a flatland road is positioned at a radially inner side of the control shaft with respect to an inner peripheral surface of the plate member.

In a further preferable configuration, the plate member faces in an axial direction of the flexible external gear.

Having described merely several embodiments of the present invention, it is apparent to those skilled in the art that the embodiments described as the examples can be modified or improved in various manners without substantially departing from the novel teachings and advantages of the present invention. Therefore, such a modified or improved embodiment is intended to be also contained in the technical scope of the present invention. The above-described embodiments may also be arbitrarily combined.

The present application claims priority under the Paris Convention to Japanese Patent Application No. 2016-151934 filed on Aug. 2, 2016. The entire disclosure of Japanese Patent Application No. 2016-151934 filed on Aug. 2, 2016 including the specification, the claims, the drawings, and the abstract is incorporated herein by reference in its entirety.

### REFERENCE SIGN LIST

11 second control shaft (control shaft)
12 second control link
13 arm link
20 housing
21 strain wave gearing speed reducer
22 driving motor (electric motor)
24 fixation flange
27 first strain wave gear output member
36 flexible external gear
37 wave generator
38 second strain wave gear fixation shaft member (internal gear)
42 second thrust plate
48 motor driving shaft (motor output shaft)
64b axial oil passage (communication passage)
281b bearing containing portion
500 strain wave gearing speed reducer containing portion
700 ball bearing
701 inner race
702 outer race
703 ball
600 drain hole (discharge oil passage)

1. An actuator configured to be used for a link mechanism for an internal combustion engine and configured to rotate a control shaft for changing an orientation of the link mechanism for the internal combustion engine, the actuator comprising:
a strain wave gearing speed reducer configured to decrease a rotational speed of an electric motor and transmit a rotation thereof to the control shaft;
a housing including a containing chamber in which the electric motor is fixed and the strain wave gearing speed reducer is also contained; and
a communication passage provided at the housing or the control shaft, the communication passage establishing communication between the containing chamber and a lubricant oil passage of the internal combustion engine,
wherein the strain wave gearing speed reducer includes
a wave generator having an elliptic outline coupled with an output shaft of the electric motor,
a flexible external gear including an external tooth on an outer periphery thereof and a cylindrical portion inserted through an outer peripheral side of the wave generator, the flexible external gear being configured to transmit a rotation of the cylindrical portion to the control shaft, and
an internal gear fixed to the housing, the internal gear including an internal tooth meshed with the flexible external gear, and
wherein the actuator includes
a roller bearing including an inner race held by one of the housing and the wave generator and an outer race held by the other of the housing and the wave generator, the roller bearing including a rolling member between the inner race and the outer race, and
a holding mechanism provided at the roller bearing or the housing, the holding mechanism being capable of holding the lubricant oil in the roller bearing on a radially inner side with respect to the outer race.

2. The actuator of the link mechanism for the internal combustion engine according to claim 1, wherein the housing includes a discharge oil passage capable of discharging the lubricant oil from the containing chamber, and
wherein a lower end portion of an opening portion of the discharge oil passage to the containing chamber in a direction of gravitational force on a flatland road is positioned at an upper side in the direction of gravitational force with respect to the holding mechanism.

3. The actuator of the link mechanism for the internal combustion engine according to claim 2, wherein the lower end portion of the opening portion of the discharge oil passage to the containing chamber in the direction of gravitational force on the flatland road is positioned at an upper side in the direction of gravitational force with respect to a lower end portion of the flexible external gear in the direction of gravitational force.

4. The actuator of the link mechanism for the internal combustion engine according to claim 3, wherein the holding mechanism includes
an extension portion provided at the housing, the extension portion facing one side of the roller bearing in a rotational axis direction, the extension portion extending radially inward beyond an inner diameter of the outer race with respect to the outer race, and
a plate member facing the other side of the roller bearing in the rotational axis direction, the plate member extending radially inward beyond the inner diameter of the outer race with respect to the outer race

5. The actuator of the link mechanism for the internal combustion engine according to claim 4, wherein the roller bearing is an open-type roller bearing.

6. The actuator of the link mechanism for the internal combustion engine according to claim 4, wherein the plate member is provided abuttably in an axial direction of the flexible external gear.

7. The actuator of the link mechanism for the internal combustion engine according to claim 4, wherein the plate member includes a portion axially facing the inner race of the roller bearing, this facing portion being formed into a stepped shape in a direction away from the inner race.

8. The actuator of the link mechanism for the internal combustion engine according to claim 4, wherein the plate member is formed into a disk-like shape.

9. The actuator of the link mechanism for the internal combustion engine according to claim 4, wherein the plate member is fixedly fastened to the housing together with the internal gear.

10. The actuator of the link mechanism for the internal combustion engine according to claim 1, wherein the holding mechanism is an extension portion integrally provided at the outer race of the roller bearing and is an extension portion extending from a radially inner side of the outer race toward the inner race of the roller bearing.

11. The actuator of the link mechanism for the internal combustion engine according to claim 1, wherein the holding mechanism is a seal member attached to the outer race of the roller bearing and is a seal member forming a space between the seal member and the inner race of the roller bearing.

12. An actuator configured to be used for a link mechanism for an internal combustion engine and configured to rotate a control shaft for changing an orientation of the link mechanism for the internal combustion engine, the actuator comprising:
a strain wave gearing speed reducer configured to decrease a rotational speed of an electric motor and transmit a rotation thereof to the control shaft;
a housing including a containing chamber in which the electric motor is fixed and the strain wave gearing speed reducer is also contained; and
a communication passage provided at the housing or the control shaft, the communication passage establishing communication between the containing chamber and a lubricant oil passage of the internal combustion engine,
wherein the strain wave gearing speed reducer includes
a wave generator having an elliptic outline coupled with an output shaft of the electric motor,
a flexible external gear including an external tooth on an outer periphery thereof and a cylindrical portion inserted through an outer peripheral side of the wave generator, the flexible external gear being configured to transmit a rotation of the cylindrical portion to the control shaft,
an internal gear fixed to the housing, the internal gear including an internal tooth meshed with the flexible external gear, and
a roller bearing including an inner race held by the wave generator and an outer race held by the housing, the roller bearing including a rolling member between the inner race and the outer race, and
wherein the actuator includes
a bearing containing portion formed in the housing, the bearing containing portion being recessed to one end side in a rotational axis direction of the wave generator, the bearing containing portion holding the outer race, and
a plate member fixed to the roller bearing or the housing, the plate member facing the other end side of the outer race in the rotational axis direction of the wave generator, the plate member extending to a radially inner side with respect to the outer race.

13. The actuator of the link mechanism for the internal combustion engine according to claim 12, wherein the housing includes a discharge oil passage capable of discharging the lubricant oil from the containing chamber, and
wherein a lower end portion of an opening portion of the discharge oil passage to the containing chamber in a direction of gravitational force on a flatland road is positioned at a radially inner side of the control shaft with respect to an inner peripheral surface of the plate member.

14. The actuator of the link mechanism for the internal combustion engine according to claim 13, wherein the plate member faces in an axial direction of the flexible external gear.
